(19) United States
(12) Patent Application Publication
(10) Pub. No.: US 2017/0124470 A1
(43) Pub. Date: May 4, 2017

(54) SEQUENCE OF CAUSES ESTIMATION DEVICE, SEQUENCE OF CAUSES ESTIMATION METHOD, AND RECORDING MEDIUM IN WHICH SEQUENCE OF CAUSES ESTIMATION PROGRAM IS STORED

(71) Applicant: NEC Corporation, Minato-ku, Tokyo (JP)

(72) Inventor: Yoshiharu MAENO, Tokyo (JP)

(73) Assignee: NEC Corporation, Minato-ku, Tokyo (JP)

(21) Appl. No.: 15/311,986

(22) PCT Filed: Jun. 2, 2015
(86) PCT No.: PCT/JP2015/002769

§ 371 Date: Nov. 17, 2016

(30) Foreign Application Priority Data
Jun. 3, 2014 (JP) 2014-114464

(51) Int. Cl. G06N 5/04; G06F 11/34; G06F 11/00

(52) U.S. Cl. CPC G06N 5/048; G06F 11/008; G06F 11/3438

(57) ABSTRACT

The present invention provides a sequence of causes estimation device, etc., with which it is possible to estimate a module that acts as a cause. A sequence of causes estimation device (101) has a sequence unit (102) that sequences modules in accordance with the degree of similarity between a numeric value pertaining to a service provided using a system, and a degree of influence representing the magnitude of an influence exerted upon the service by a module included in the system.

### TECHNICAL FIELD

The present invention relates to a causes ordering estimation device and the like that enable estimation of causes of phenomena occurring in a system.

### BACKGROUND ART

PTLs 1 to 5 disclose techniques relating to systems that manage prediction models for enabling prediction of availability. Prediction models include various kinds of information such as mathematical models for calculating, examining, or analyzing availability, calculating formulas, parameters, and configurations and behavior of systems. These systems estimate an operation rate of the entire system, for example, on the basis of the predicted availability.

PTL 1 discloses a method for predicting, in a computer included in the system, an operation rate of the entire system on the basis of properties, such as a failure rate and time required for restoring a failure, and monitoring information relating to a failure that occurs when the system is in operation.

According to a method disclosed in PTL 2, a fault tree that is a tool for analyzing a failure state is first composed on the basis of configuration information relating to software included in a system or hardware included in a system. According to the method a failure rate (a failure degree) is further calculated on the basis of the fault tree, to determine whether the calculated failure rate is less than a reference value or not.

According to a method disclosed in PTL 3, information relating to functionality, configuration, security, performance, and the like, and availability for an application program or an application service are stored as metadata upon installation of them. According to the method, configuration management, fault detection, diagnosis, recovery, and the like after the installation are further analyzed based on the stored metadata.

According to a method disclosed in PTL 4, every time a malfunction occurs in a providing service (a failure occurs), a period during a continuation of the failure and the number of users who cannot use the service due to the failure are stored. According to the method, a ratio of the failure period within a certain period, a ratio of users who cannot use the service due to the failure among expected users who use the service, an operation rate or the like are further estimated based on the stored period and the stored number of users.

For hardware, methods for analyzing availability of the hardware by using a mathematical model, such as a fault tree, on the basis of characteristics of components of the hardware, are widely known.

For software, methods for analyzing availability in accordance with a mathematical model, such as a stochastic Petri network and a stochastic reward network, are known. In such a model, transition among system states is described and the system is simulated based on the described model. Availability of the system is analyzed by reproducing the way that the state transits in the simulation.

PTL 5 discloses a simulator system being capable of evaluating availability relating to a computer system. The simulator system includes a client simulator and an evaluation unit. The client simulator transmits a signal to each client device in the computer system and measures a response time that elapses until the client device replies in response to the transmitted signal. The evaluation unit estimates influence that a failure occurring in the client device exerts on the response time on the basis of the response time measured for each client device.

### PRIOR ART LITERATURE

### Patent Literature

PTL 1: Japanese Patent Application Laid-Open Publication No. 2008-532170

PTL 2: Japanese Patent Application Laid-Open Publication No. 2006-127464

PTL 3: Japanese Patent Application Laid-Open Publication No. 2007-509404

PTL 4: Japanese Patent Application Laid-Open Publication No. 2005-080104

PTL 5: Japanese Patent Application Laid-Open Publication No. 2007-122416

### SUMMARY OF THE INVENTION

### Technical Problem

However, even when availability is analyzed by using devices disclosed in PTLs 1 to 5, an administrator managing a data center experiences difficulty in predicting a component (a factor, or a module) that causes a certain phenomenon (for example, a complaint received from a user). This is because, even when the administrator analyzes availability of the data center with such devices, the administrator cannot quantitatively associate the phenomenon occurring in the data center with a module included in the data center.

For example, even when the administrator calculates availability relating to the data center in accordance with a stochastic petri network, the administrator cannot predict a module that causes a complaint on the basis of the complaint relating to the data center.

Thus, the main objective of the present invention is to provide a causes ordering estimation device and the like that enable estimation of a module that causes a phenomenon (an incident) occurring in a system.

### Solution to Problem

In order to achieve the aforementioned object, as an aspect of the present invention, a causes ordering estimation device including:

ordering means that determines an order of modules in accordance with a degree of similarity between a numeric value relating to a service provided by using a system and a degree of influence representing a magnitude of influence that the module in the system exerts on the service.

In addition, as another aspect of the present invention, a causes ordering estimation method including:

determining an order of modules in accordance with a degree of similarity between a numeric value relating to a service provided by using a system and a degree of influence representing a magnitude of influence that the module in the system exerts on the service.

Furthermore, the object is also realized by a causes ordering estimation program, and a computer-readable recording medium which records the program.

### Advantageous Effects of Invention

The causes ordering estimation device and the like according to the present invention enable estimation of a module that causes a phenomenon occurring in a system.

### BRIEF DESCRIPTION OF DRAWINGS

FIG. 1 is a block diagram illustrating components of a causes ordering estimation device according to a first example embodiment of the present invention.

FIG. 2 is a flowchart illustrating the flow of the processing of the causes ordering estimation device according to the first example embodiment.

FIG. 3 is a diagram conceptually illustrating an example of a numerical information.

FIG. 4 is a diagram conceptually illustrating an example of numerical information that a causes ordering estimation device can receive.

FIG. 5 is a diagram conceptually illustrating an example of a structure of module influence information.

FIG. 6 is a diagram conceptually illustrating an example of a structure of the ordering information.

FIG. 7 is a diagram conceptually illustrating an example of ordering information that is generated when numerical information represents a number of complaints.

FIG. 8 is a diagram conceptually illustrating an example of ordering information that is generated when numerical information represents maintenance counts.

FIG. 9 is a block diagram illustrating components of a causes ordering estimation device according to a second example embodiment of the present invention.

FIG. 10 is a flowchart illustrating a flow of the processing of a causes ordering estimation device according to the second example embodiment.

FIG. 11 is a diagram conceptually illustrating an example of relation information.

FIG. 12 is a diagram conceptually illustrating an example of module information.

FIG. 13 is a diagram conceptually illustrating an example of service information.

FIG. 14 is a diagram illustrating an example of components of an analysis target system.

FIG. 15 is a flowchart illustrating a flow of processing when a similarity calculation unit generates influence information.

FIG. 16 is a block diagram schematically illustrating a hardware configuration of a calculation processing apparatus capable of realizing the causes ordering estimation device according to each example embodiment of the present invention.

FIG. 17 is a diagram conceptually illustrating an example of a stochastic petri network that describes a state transition relating to an information system or the like.

FIG. 18 is a diagram conceptually illustrating an example of a stochastic petri network that describes a state transition relating to an information system or the like.

FIG. 19 is a diagram conceptually illustrating an example of a stochastic petri network that describes a state transition relating to an information system or the like.

### DESCRIPTION OF EMBODIMENTS

To facilitate understanding of the present invention, terms used in the claimed description will be described preliminarily.

Availability refers to a ratio of a period during which a user can use a service to a certain period. Availability may be used synonymously with an operation rate.

For example, if a service is not available for one minute per day on average, the availability is 99.93 (=1−1+(24×60))%.

Availability is calculated based on mean time between failure and mean time to repair that is a time required for recovering from a failure (a breakdown).

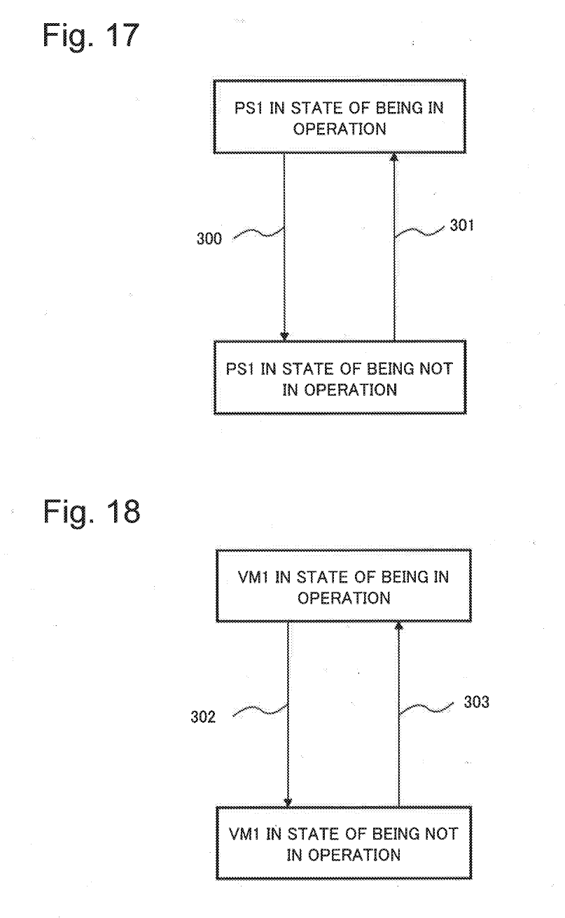

For example, availability is calculated based on a stochastic petri network (stochastic reward network) formed by combining the state transitions exemplified in FIGS. 17 to 19. FIGS. 17 to 19 are diagrams each conceptually illustrating an example of a stochastic petri network that describes a state transition relating to an information system or the like.

For example, suppose an information system exhibits state transitions as exemplified in FIGS. 17 to 19. That is, the information system includes a physical server PS1. The physical server PS1 executes actual processes relating to a virtual server VM1. The virtual server VM1 executes processes according to an application AP1. The virtual server is also referred to as a virtual machine (VM).

In an example illustrated in FIG. 17, the physical server PS1 can transit between two states; a state of being in operation and a state of being not in operation. The state of being in operation is a state where the physical server PS1 is operating. The state of being not in operation is a state where the physical server PS1 stops its functions.

Further, as illustrated in FIG. 18, the virtual server VM1 can transit between two states; a state of being in operation and a state of being not in operation. The state of being in operation is a state where the virtual server VM1 is operating. The state of being not in operation is a state where the virtual server VM1 stops its functions.

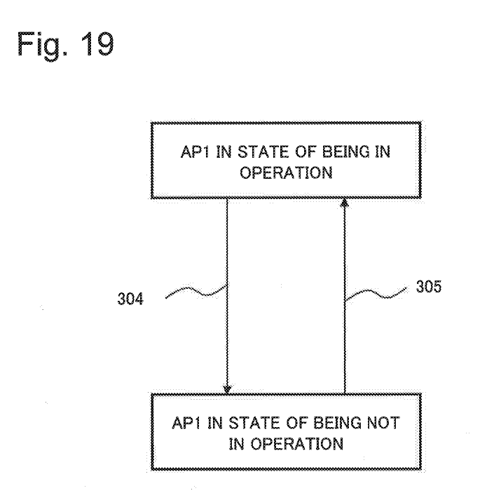

Likewise, as illustrated in FIG. 19, the application AP1 can transit between two states; a state of being in operation and a state of being not in operation. The state of being in operation is a state where the application AP1 is operating. The state of being not in operation is a state where the application AP1 stops its functions.

The above-described virtual server VM1 is not allocated to a hypervisor but is allocated to a user, and further allows the user to access itself (that is, a user VM). A hypervisor, which is accessible only by an administrator who is managing the data center, is a control program that controls the virtual server VM1.

An arrow between the two states in the examples of FIGS. 17 to 19 indicates a state transition between the two states. In FIG. 18, an arrow 302 from a state of being in operation to a state of being not in operation indicates transition of the virtual server VM1 from the state of being in operation to the state of being not in operation, for example, due to any failure. In FIG. 18, an arrow 303 from a state of being not in operation to a state of being in operation indicates transition of the virtual server VM1 from the state of being not in operation to the state of being in operation when the cause of the failure is recovered. In FIG. 17, an arrow 300 indicates transition of the physical server PS1 from a state of being in operation to a state of being not in operation. In FIG. 17, an arrow 301 indicates transition of the physical server PS1 from the state of being not in operation to the state of being in operation. In FIG. 19, an arrow 304 indicates transition of the application AP1 from a state of being in operation to a state of being not in operation. In FIG. 19, an arrow 305 indicates transition of the application AP1 from the state of being not in operation to the state of being in operation.

The state transition of the virtual server VM1 depends on the state of the physical server PS1. For example, the physical server PS1 performs processing relating to the virtual server VM1. When the physical server PS1 is in the state of being not in operation, the virtual server VM1 is also in the state of being not in operation.

Thus, when the physical server PS1 stops, the virtual server VM1 transits from the state of being in operation to the state of being not in operation with transition rate 1 (arrow 302). Further, when the physical server PS1 is in the state of being in operation, the virtual server VM1 transits from the state of being in operation to the state of being not in operation with transition rate λ_{VM1} (arrow 302).

The transition rate may be, for example, a probability indicating the likelihood of transition from the state of being in operation to the state of being not in operation. Similarly, the transition rate can also be defined as a probability for transition from the state of being not in operation to the state of being in operation.

In the examples illustrated in FIGS. 17 to 19, when the physical server PS1 is in the state of being not in operation, the transition rate of the virtual server VM1 transiting from the state of being not in operation to the state of being in operation is 0 (arrow 303). Whereas, when the physical server PS1 is in the state of being in operation, the virtual server VM1 transits from the state of being not in operation to the state of being in operation with a transition rate μ_{VM1} (arrow 303). Similarly, when the virtual server VM1 stops, the application AP1 transits from the state of being in operation to the state of being not in operation with a transition rate 1 (arrow 304). Further, when the virtual server VM1 is in the state of being in operation, the application AP1 transits from the state of being in operation to the state of being not in operation with a transition rate λ_{AP1} (arrow 304). When the virtual server VM1 is in the state of being not in operation, the transition rate of the application AP1 transiting from the state of being not in operation to the state of being in operation is 0 (arrow 305). Further, when the virtual server VM1 is in the state of being in operation, the application AP1 transits from the state of being not in operation to the state of being in operation with a transition rate μ_{AP1} (arrow 305). Further, the physical server PS1 transits from the state of being in operation to the state of being not in operation with a transition rate λ_{PS1} (arrow 300). The physical server PS1 transits from the state of being not in operation to the state of being in operation with a transition rate μ_{PS1} (arrow 301).

For example, the availability of an information system and the availability of the components in the information system are analyzed by a simulation of the states of the components constituting the information system on the basis of a stochastic petri network. In the cases of the examples of FIGS. 17 to 19, the availability of the application AP1 is calculated on the basis of the probability of being in the state of being not in operation when the application AP1 is in a steady state (that is, the state of the application is not changed) according to the result of the simulation. For example, the availability can be calculated by summing the probabilities of the application AP1 being in the state of not in operation when in a steady state and then subtracting the calculated sum from 1. Alternatively, the availability may be calculated by summing the probabilities of the application AP1 being in the state of being in operation when in a steady state.

The method of calculating availability is not limited to the above examples.

The administrator for the data center analyzes the availability relating to the data center by generating a stochastic petri network on the basis of the characteristics relating to the infrastructure of the data center (a server infrastructure) and according to an operation procedure relating to the data center. As such, the method for predicting availability depends on, for example, an operation procedure relating to the data center.

The following will describe the details of the example embodiments of the present invention with reference to the drawings.

### First Example Embodiment

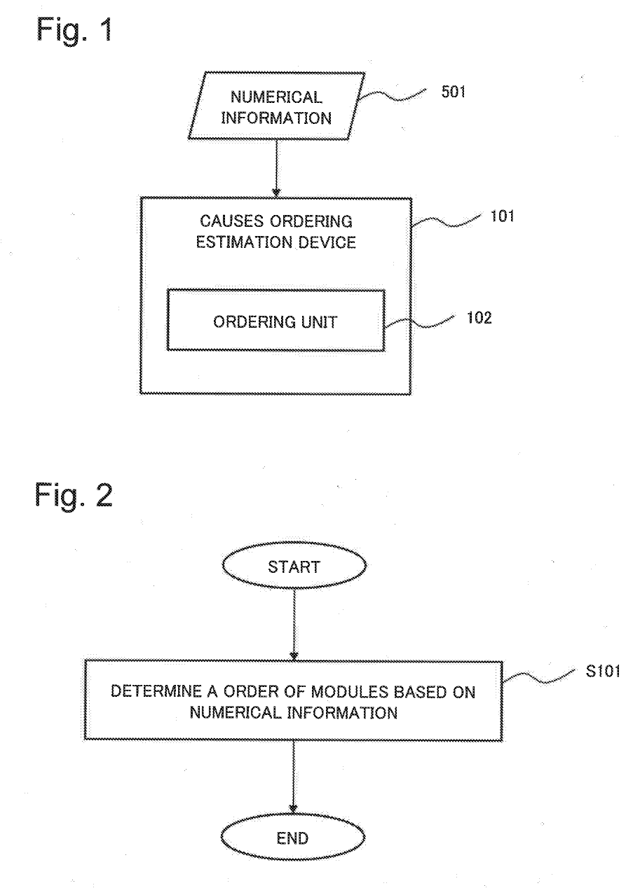

The components of a causes ordering estimation device 101 according to a first example embodiment of the present invention and the processing performed by the causes ordering estimation device 101 will be described in detail with reference to FIGS. 1 and 2. FIG. 1 is a block diagram illustrating the components of the causes ordering estimation device 101 according to the first example embodiment of the present invention. FIG. 2 is a flowchart illustrating the flow of the processing of the causes ordering estimation device 101 according to the first example embodiment.

The causes ordering estimation device 101 according to the first example embodiment includes an ordering unit 102.

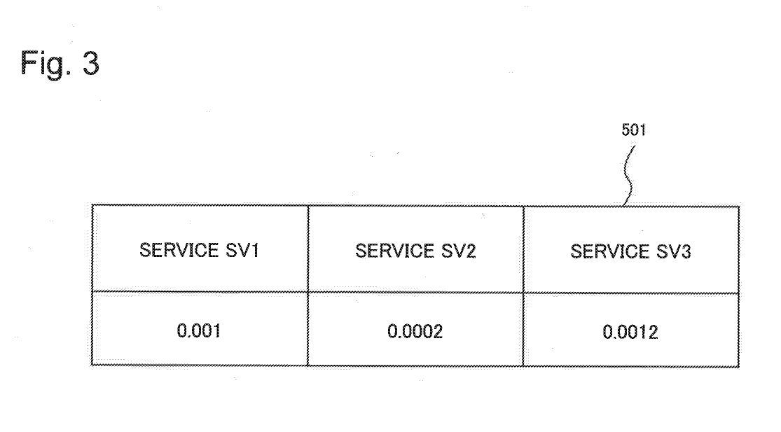

First, the causes ordering estimation device 101 receives, for example, numerical information 501 as exemplified in FIG. 3. FIG. 3 is a diagram conceptually illustrating an example of the numerical information 501.

The numerical information 501 is information generated by a combination of one or more numeric values. For example, in the example illustrated in FIG. 3, the numerical information 501 includes three numeric values such as 0.001, 0.0002, and 0.0012. These numeric values are, for example, the degree of influence representing the magnitude of influence that an analysis target system exerts on a service SV1, the degree of influence representing the magnitude of influence that the analysis target system exerts on a service SV2, and the degree of influence representing the magnitude of influence that the analysis target system exerts on a service SV3. That is, in the example illustrated in FIG. 3, the numerical information 501 is a three-dimensional vector including the degrees of influence exerted on the services SV1 to SV3. The larger these numeric values are, the greater the influence on the services may be. The numerical information 501 may be preset information.

For convenience of description, it is assumed in the following description that qualities of the system degrade, as the above-described numeric values are larger.

The degree of influence is, for example, a stop time rate of a system, which indicates the ratio of time (duration) during which the system could not provide the service to users over the past year. That is, in FIG. 3 that illustrates numerical information representing the degrees of influence, the stop time rate for the service SV1 is 0.001; the stop time rate for the service SV2 is 0.0002; and, the stop time rate for the service SV3 is 0.0012. In such a case, the numerical information 501 is a three-dimensional vector formed by the stop time rates for the services SV1 to SV3.

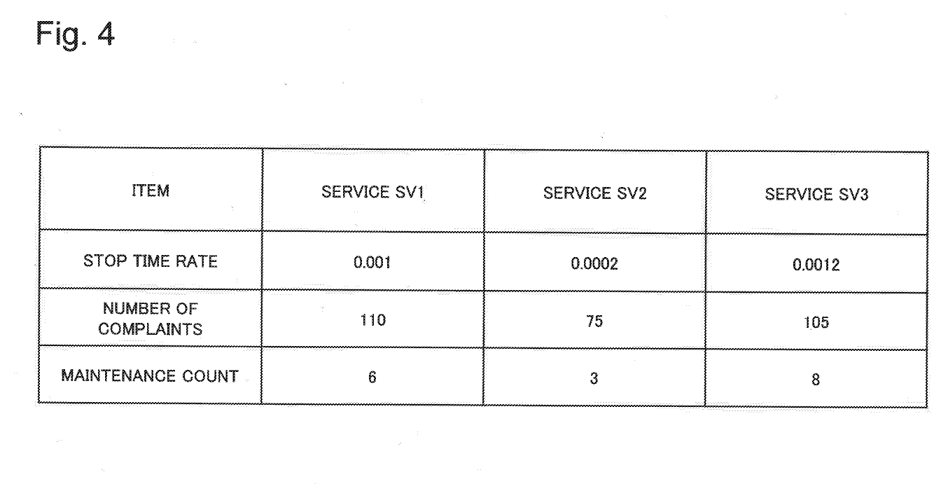

As illustrated in FIG. 4, the degrees of influence may be represented, for example, by items, such as the number of complaints to services and the maintenance counts of services. FIG. 4 is a diagram conceptually illustrating an example of numerical information 501 that the causes ordering estimation device 101 can receive. As such, the degrees of influence as illustrated in FIG. 3 are not limited to the above-described example nor to the example illustrated in FIG. 4.

In the example illustrated in FIG. 4, the number of complaints relating to the service SV1 is 110; the number of complaints relating to the service SV2 is 75; and the number of complaints relating to the service SV3 is 105. The number of complaints may represent the number of complaints that have been received from users over the past year. In such a case, the numerical information 501 is represented as a three-dimensional vector formed by the numbers of complaints relating to the services SV1 to SV3.

In the example illustrated in FIG. 4, the maintenance count relating to the service SV1 is 6; the maintenance count relating to the service SV2 is 3; and the maintenance count relating to the service SV3 is 8. In such a case, the numerical information 501 is represented as a three-dimensional vector formed by the maintenance counts relating to the services SV1 to SV3.

The numerical information 501 may also include the number of cancellations that the users have cancelled the services over the past year, actual values representing the actual magnitudes of influence exerted on the services, and other values. The numerical information 501 is not limited to the above-described examples.

Next, the ordering unit 102 determines an order of modules (that is, determines the order of the modules) in the system on the basis of the received numerical information 501 (step S101).

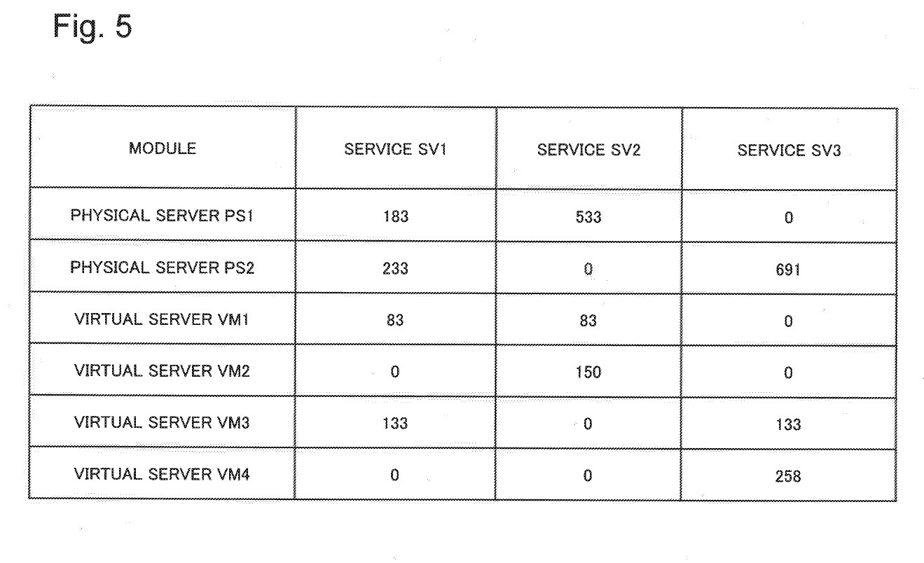

For example, the ordering unit 102 reads the module influence information as exemplified in FIG. 5 and determines the order of the modules in the system on the basis of the read module influence information and the numerical information 501. FIG. 5 is a diagram conceptually illustrating an example of the structure of the module influence information.

The module influence information may be input from outside or generated by the causes ordering estimation device 101, as will be described later. In the first example embodiment, modules are elements that constitute (are included in) a system and represent functional units implemented by software, hardware, or a combination thereof.

Referring to the example illustrated in FIG. 5, the module influence information includes the degrees of influence relating to a physical server PS1, a physical server PS2, a virtual server VM1, a virtual server VM2, a virtual server VM3, and a virtual server VM4. This indicates that the modules included in the system are the physical server P51, the physical server PS2, the virtual server VM1, the virtual server VM2, the virtual server VM3, and the virtual server VM4. In other words, the module influence information illustrated in FIG. 5 indicates that the analysis target system includes the above-described six modules.

Of the module influence information exemplified in FIG. 5, a value in a column identified by the service name of a service in a row identified by the module name of a module indicates the degree of influence that the module exerts on the service. Referring to FIG. 5, for example, the physical server PS1 is associated with values “183”, “533”, and “0”. In such a case, as the value “183” is a value in a column identified by the service SV1, the value indicates the degree of influence that the physical server PS1 exerts on the service SV1. Likewise, for example, the virtual server VM1 is associated with the values “83”, “83”, and “0”. In such a case, as the value “0” is a value in a column identified by the service SV3, the value indicates the degree of influence that the virtual server VM1 exerts on the service SV3. As such, the module influence information associates the above-described modules with the degrees of influence that the modules exert on the services.

As such, in the module influence information exemplified in FIG. 5, the degree of influence that the physical server PS1 exerts on the service SV1 is 183; the degree of influence that the physical server PS1 exerts on the service SV2 is 533; and the degree of influence that the physical server PS1 exerts on the service SV3 is 0. Similarly, in the example illustrated in FIG. 5, the degree of influence that the virtual server VM2 exerts on the service SV1 is 0; the degree of influence that the virtual server VM2 exerts on the service SV2 is 150; and the degree of influence that the virtual server VM2 exerts on the service SV3 is 0.

These degrees of influence may be the actual values indicating the magnitudes of influence that the modules exert on the services or may be values calculated by the causes ordering estimation device 101, as will be described later. The degrees of influence may be 0 or positive values in the same way as the numerical information 501. The influence of the modules exerted on the services becomes greater, as the values of the degrees of influence are larger.

For example, the ordering unit 102 reads the degrees of influence relating to a module from the module influence information. That is, the ordering unit 102 reads a three-dimensional vector including the degrees of influence on the services SV1 to SV3 as shown in the first row of the module influence information exemplified in FIG. 5 (which represents the degrees of influence relating to the physical server PS1). Next, the ordering unit 102 normalizes, for example, the vector including the read degrees of influence (refer to the “first vector” for convenience) and the vector shown as the numerical information 501 (refer to the “second vector” for convenience), respectively. That is, the ordering unit 102 normalizes the first vector by dividing each of the elements included in the first vector by the size of the first vector. Similarly, the ordering unit 102 normalizes the second vector.

The vector shown as the numerical information 501 is, for example, a three-dimensional vector including the degrees of influence exemplified in FIG. 3. Among vectors shown as the numerical information 501 exemplified in FIG. 4, for example, a vector relating to the row indicating the “number of complaints” is a three-dimensional vector including the degrees of influence. In the case of the numerical information 501 exemplified in FIG. 4, the ordering unit 102 normalizes a vector relating to a specified row.

Next, the ordering unit 102 calculates an inner product of the normalized vectors (i.e., the normalized first and second vectors). In such a case, the inner product indicates the degree of similarity representing how much the vectors are relevant to each other.

In the first example embodiment, the degree of similarity is defined as the cosine of an angle between vectors, that is, an inner product calculated for normalized vectors. If the angle is 0° (degree), the degree of similarity is 1. If the angle is 90° (degrees), the degree of similarity is 0. As such, the vectors are more relevant as the degree of similarity is closer to 1.

While assuming that the ordering unit 102 reads the degrees of influence relating to the physical server PS1 in the above description, the ordering unit 102 performs similar processing for other modules, such as the physical server PS2 and the virtual server VM3. Further, it is assumed in the above-described example that the vector is three-dimensional, but the vector is not necessarily three-dimensional.

The ordering unit 102 calculates a first vector for each module specified by the module influence information and calculates the degree of similarity between the calculated first vector and the second vector.

Next, the ordering unit 102 determines an order of the modules in the system on the basis of the calculated degrees of similarity. The ordering unit 102 calculates higher orders for modules with larger degrees of similarity. As such, the higher the likelihood of a module causing numerical information 501 is, the higher the degree of similarity becomes and, thus, the calculated order becomes higher.

While the ordering unit 102 estimates the degree of similarity by calculating an inner product as in the above-described example, the ordering unit 102 may estimate the degree of similarity by calculating a distance. That is, the ordering unit 102 may calculate, as the degree of similarity, a distance between the normalized numerical information 501 and the normalized degrees of influence. For example, the distance is expressed by Eqn. 1 as the size of a difference vector between the vectors.

|(Normalized degrees of influence)−(Normalized numerical information 501)| (Eqn. 1)

(where ∥ indicates the size.)

For example, the size may be a geometric distance, a Manhattan distance, a generalized Mahalanobis distance, and the like. In such a case, the degree of similarity is larger as the distance is shorter. That is, the order becomes higher with a shorter distance.

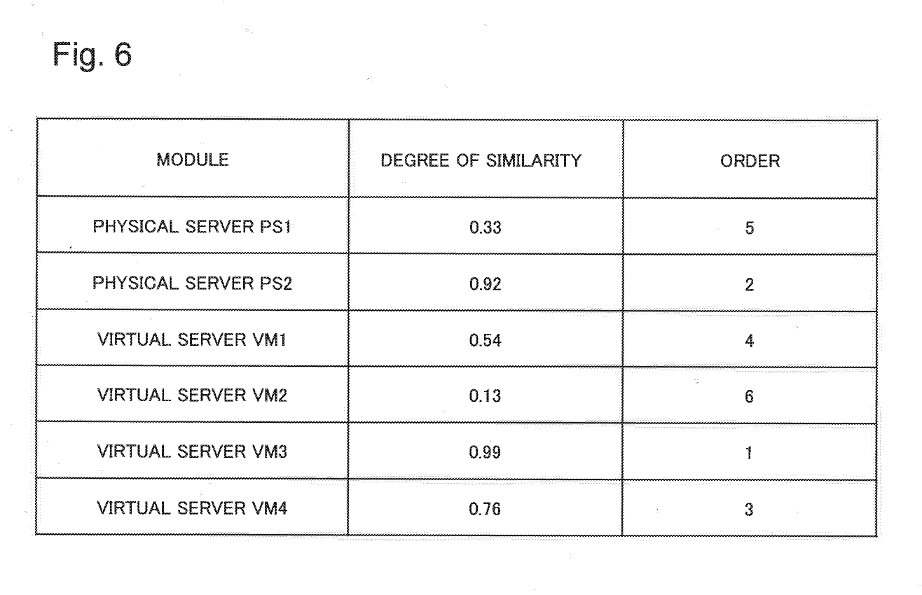

Alternatively, the ordering unit 102 may generate the calculated order as the ordering information as exemplified in FIG. 6. FIG. 6 is a diagram conceptually illustrating an example of the structure of the ordering information.

In the ordering information, a module is associated with a degree of similarity and an order. For example, the physical server PS1 is associated with 0.33 and 5. This represents that the degree of similarity calculated by the ordering unit 102 for the physical server PS1 is 0.33. Further, five in the ordering information represents that the order of the physical server PS1 is fifth when the degrees of similarity calculated for the modules of the analysis target system are arranged in a descending order.

For example, the virtual server VM1 is associated with 0.54 and 4. This indicates that the degree of similarity calculated by the ordering unit 102 for the virtual server VM1 is 0.54. Further, four in the ordering information indicates that the order of the virtual server VM1 is fourth when the degrees of similarity calculated for the modules of the analysis target system are arranged in a descending order.

In the example illustrated in FIG. 6, the virtual server VM3 is the first order. This indicates that the virtual server VM3 has the highest likelihood of causing the numerical information 501 from among the modules of the analysis target system.

For example, the administrator can select a module causing the numerical information 501 in the analysis target system on the basis of the order calculated by the ordering unit 102. Thus, in the case of the example illustrated in FIG. 6, the administrator may select the virtual server VM3, that is estimated as a factor causing the numerical information 501, as a module to be removed based on the fact that the virtual server VM3 is the first order.

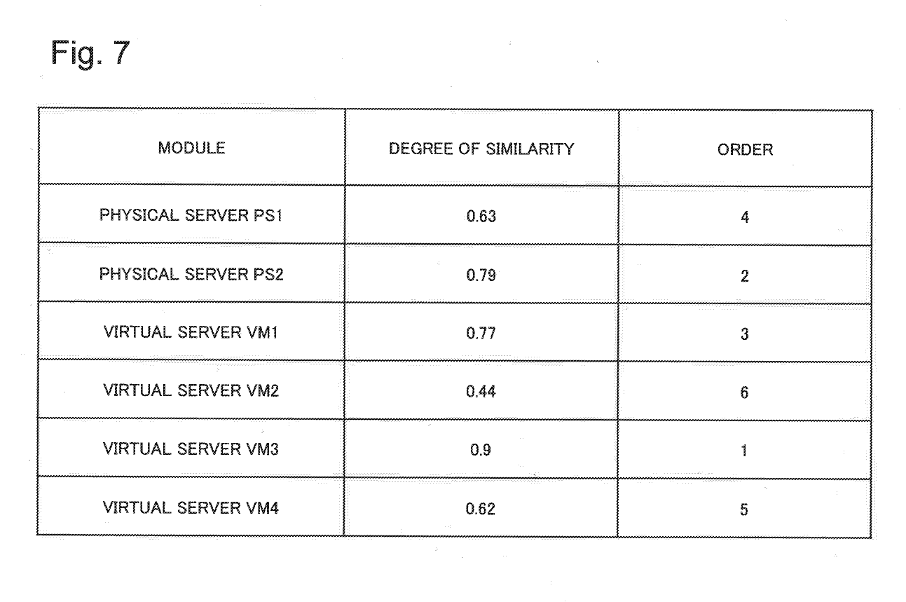

If the numerical information 501 represents the number of complaints exemplified in FIG. 4, the ordering unit 102 generates the ordering information where modules are ordered as exemplified in FIG. 7. FIG. 7 is a diagram conceptually illustrating an example of the ordering information that is generated when numerical information 501 represents the number of complaints. In this example, when the numerical information 501 is the number of complaints, the ordering unit 102 generates ordering information that is different from the ordering information exemplified in FIG. 6.

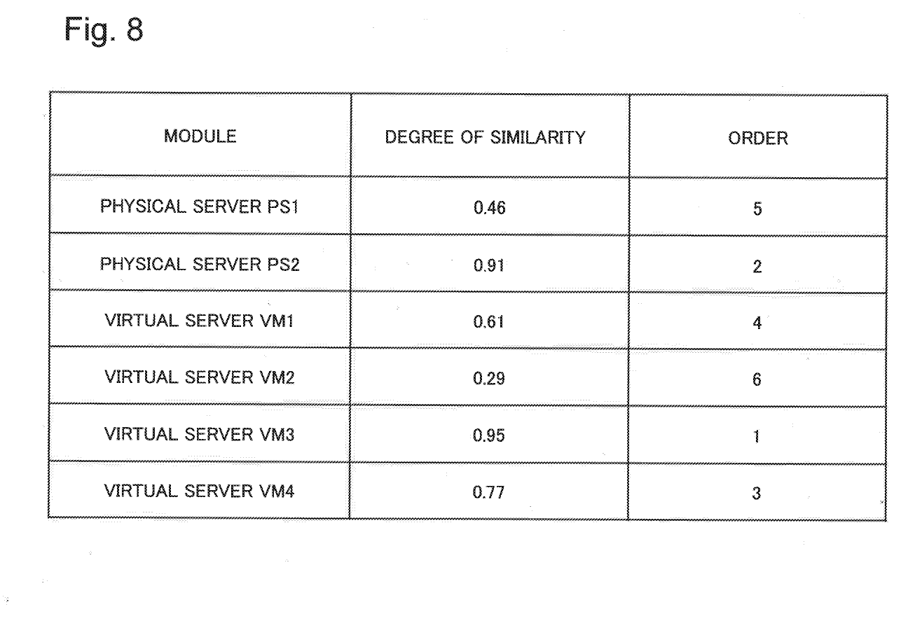

If the numerical information 501 represents maintenance counts exemplified in FIG. 4, the ordering unit 102 generates the ordering information where the modules are ordered as exemplified in FIG. 8. FIG. 8 is a diagram conceptually illustrating an example of the ordering information that is generated when numerical information 501 represents maintenance counts. In this example, when the numerical information 501 is maintenance counts, the ordering unit 102 generates ordering information that is different from the ordering information exemplified in FIG. 6 and the ordering information exemplified in FIG. 7.

The following will describe the effect of the causes ordering estimation device 101 according to the first example embodiment.

The causes ordering estimation device 101 according to the first example embodiment can estimate a module that causes the numerical information 501 in an analysis target system.

This is because the causes ordering estimation device 101 generates the ordering information where the modules are ordered based on the degrees of similarity between the numerical information 501 and the module influence information of the modules. In such a case, the administrator of the system can estimate, for example, a module that may cause the numerical information 501 by selecting a module of a higher order on the basis of the ordering information.

On the other hand, the devices disclosed in PTLs 1 to 5 cannot estimate a module that may cause the numerical information 501 in an analysis target system. This is because these devices do not have a function of analyzing modules that influence the numerical information 501.

### Second Example Embodiment

The following will describe a second example embodiment of the present invention on the basis of the above-described first example embodiment.

The following description will mainly describe the features of the second example embodiment. The same components as the above-described first example embodiment will be appended with the same reference numerals to omit redundant descriptions.

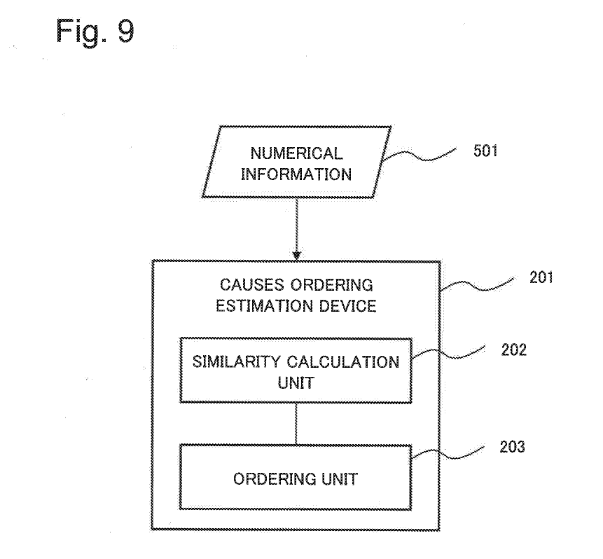

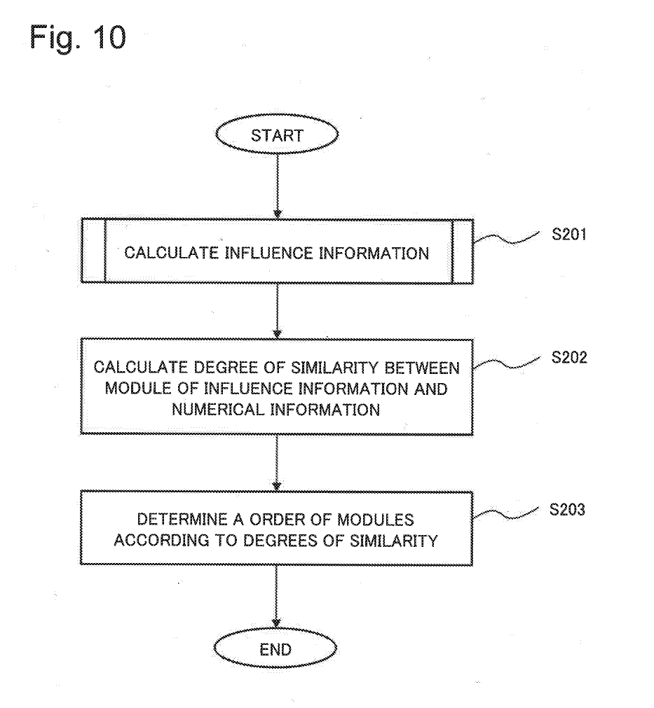

The components of a causes ordering estimation device 201 according to the second example embodiment and the processing performed by the causes ordering estimation device 201 will be described with reference to FIGS. 9 and 10. FIG. 9 is a block diagram illustrating the components of the causes ordering estimation device 201 according to the second example embodiment of the present invention. FIG. 10 is a flowchart illustrating a flow of the processing of the causes ordering estimation device 201 according to the second example embodiment.

The causes ordering estimation device 201 according to the second example embodiment includes a similarity calculation unit 202 and an ordering unit 203.

First, the similarity calculation unit 202 generates module influence information on the basis of, for example, a recovery rate (a recovery degree) that indicates how easily an application program (hereinafter, referred to as an “application”) involved in a service can be recovered from a failure (step S201). The processing of step S201 will be described later. The ordering unit 203 receives the numerical information 501. The ordering unit 203 calculates the degrees of similarity, as illustrated in the first example embodiment, on the basis of the numerical information 501 and the module influence information generated by the similarity calculation unit 202 (step S202). Next, the ordering unit 203 determines an order of the modules in the analysis target system on the basis of the degrees of similarity (step S203).

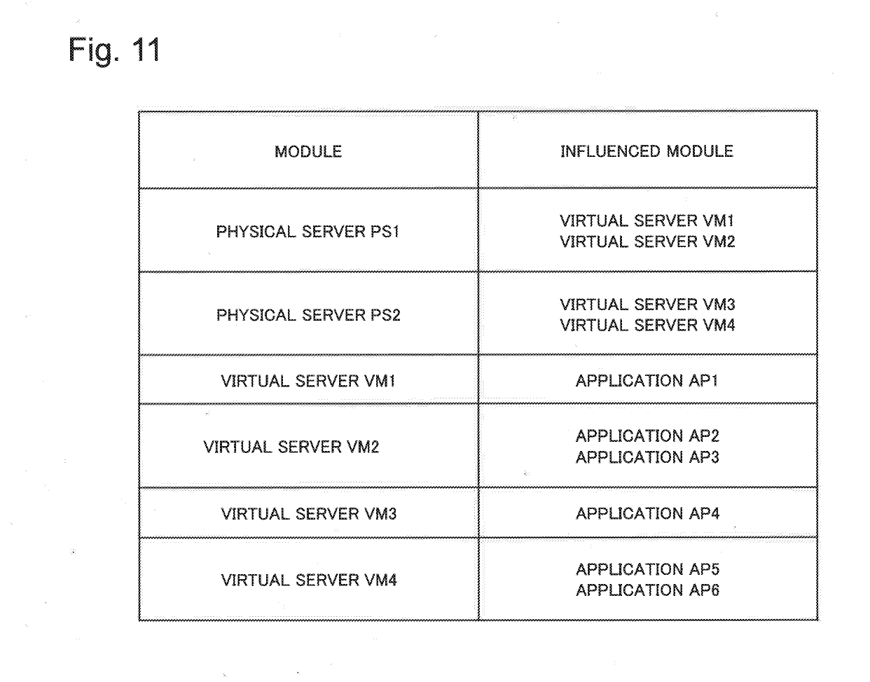

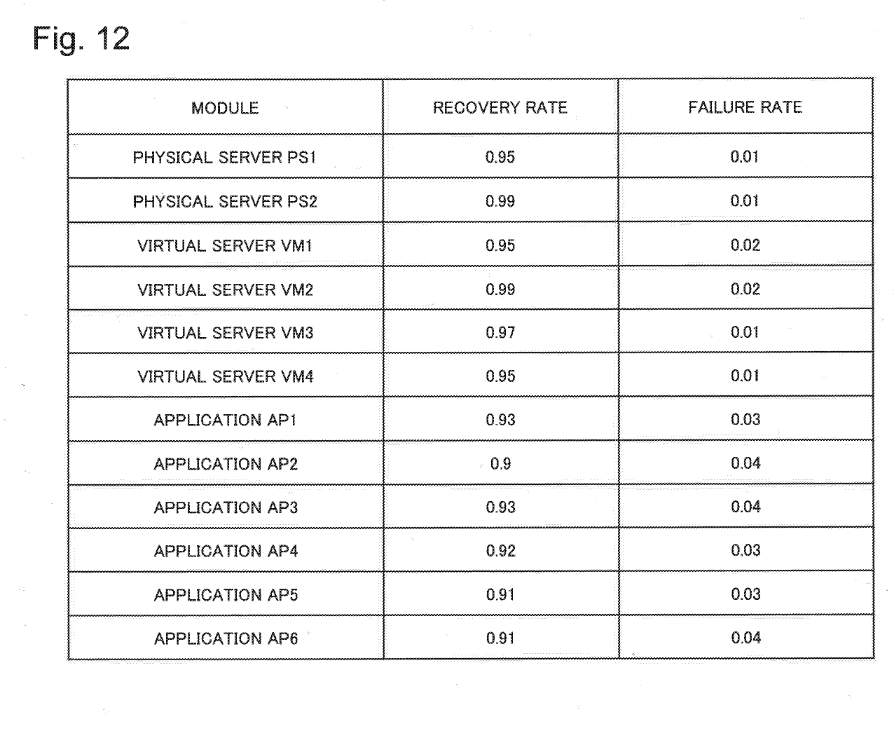

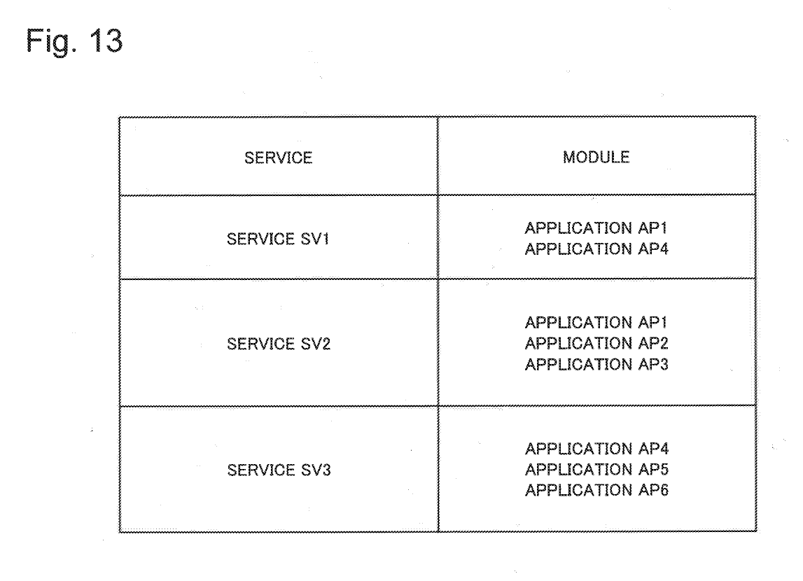

First, relation information, module information, and service information that are referred to in the processing of step S201 will be described in detail with reference to FIGS. 11 to 13. FIG. 11 is a diagram conceptually illustrating an example of the relation information. FIG. 12 is a diagram conceptually illustrating an example of the module information. FIG. 13 is a diagram conceptually illustrating an example of the service information.

In the relation information exemplified in FIG. 11, a module included in an analysis target system and another module that is influenced by the change of the state of the former module are associated. The fields of the modules in the relation information exemplified in FIG. 11 include a physical server PS1, a physical server PS2, virtual servers VM1 to VM4, and applications AP1 to AP6. This indicates that the analysis target system includes the physical server PS1, physical server PS2, virtual servers VM1 to VM4, and applications AP1 to AP6.

For example, in the relation information exemplified in FIG. 11, the physical server PS1 and the virtual servers VM1 and VM2 are associated. This indicates that the state of the physical server PS1 influences the state of the virtual server VM1 and the state of the virtual server VM2. Further, the virtual server VM4 is associated with the applications AP5 and AP6. This indicates that the state of the virtual server VM4 influences the state of the application AP5 and the state of the application AP6.

The relation information may take a form of a relational database table or a file in a text format. The relation information is updated, for example, when a module is added to the analysis target system or a module is deleted from the system. The relation information is also updated when a relationship between the modules is updated.

The modules may further include virtual servers, network routers, applications, or the like, as well as physical servers. The modules in the relation information are associated with identifiers (for example, virtual server identifiers, network router identifiers, application identifiers, and the like) that can uniquely identify the individual modules.

The module information exemplified in FIG. 12 associates a module, a recovery rate that indicates the likelihood of transition of the module from a state of being not in operation to a state of being in operation, and a failure rate that indicates the likelihood of transition of the module from the state of being in operation to the state of being not in operation. Referring to the module information exemplified in FIG. 12, for example, a virtual server VM3 is associated with 0.97 and 0.01. This indicates that the recovery rate of the virtual server VM3 is 0.97, and the failure rate of the virtual server VM3 is 0.01.

The recovery rate and the failure rate are in the range of 0 to 1 where possibility becomes higher as the value is closer to 1.

For example, when a new module is added to an analysis target system, the new module may be added to the module information. Further, when a module is deleted from an analysis target system, the module may be deleted from the module information. Further, when a recovery rate and the like of a module are updated, the module information may be updated.

Further, in the service information exemplified in FIG. 13, a service provided by applications in the system and the applications in the service are associated with one another. In the service information exemplified in FIG. 13, for example, a service SV2 is associated with applications AP1, AP2, and AP3. This indicates that the service SV2 involves the applications AP1, AP2, and AP3.

When a new service is introduces in analysis target system, the new service may be added to the service information. Further, when a service is deleted from an analysis target system, the service may be deleted from the service information. Further, when a service is changed, the service information may be updated.

The administrator may set the relation information exemplified in FIG. 11, the module information exemplified in FIG. 12, and the service information exemplified in FIG. 13 through a communication network or may input the relation information, the module information, and the service information from a keyboard.

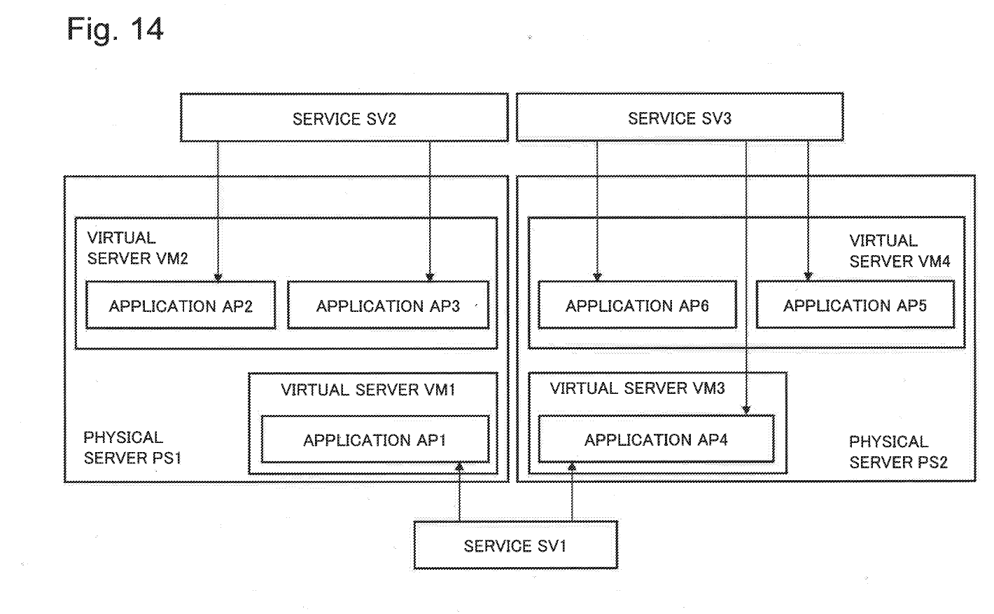

The system relating to the relation information exemplified in FIG. 11, the module information exemplified in FIG. 12, and the service information exemplified in FIG. 13 include the modules exemplified in FIG. 14. FIG. 14 is a diagram illustrating an example of components of an analysis target system.

In the example illustrated in FIG. 14, the physical server PS1 includes virtual servers VM1 and VM2. As such, when the physical server PS1 stops, the virtual servers VM1 and VM2 also stop. This is illustrated that the physical server PS1 is associated with the virtual servers VM1 and VM2 in the relation information exemplified in FIG. 11.

Referring to FIG. 14, the virtual server VM1 includes an application AP1. Further, the virtual server VM2 includes applications AP2 and AP3. Further, the physical server PS2 includes virtual servers VM3 and VM4. The virtual server VM3 includes an application AP4. The virtual server VM4 includes applications AP5 and AP6.

For example, if the first module includes the second module, the first module is associated with the second module in the relation information exemplified in FIG. 11. As such, the inclusion relation among the modules as exemplified in FIG. 14 can be expressed as the relation information exemplified in FIG. 11.

When generating module influence information, the similarity calculation unit 202 calculates the degree of influence that represents the likelihood of a specific module influencing a specific service.

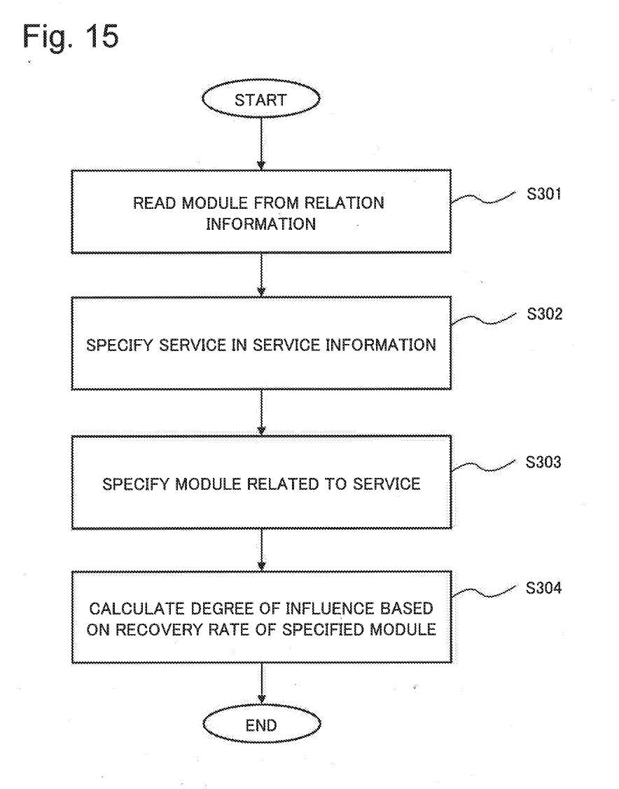

Next, with reference to FIG. 15, the processing indicated at step S201 of FIG. 10 will be described. FIG. 15 is a flowchart illustrating a flow of the processing when the similarity calculation unit 202 generates influence information.

First, the similarity calculation unit 202 reads modules that are associated with one another in the relation information (step S301). For example, the similarity calculation unit 202 reads the virtual servers VM3 and VM4 by reading modules associated with the physical server PS2 from the relation information exemplified in FIG. 11. Next, the similarity calculation unit 202 reads the application AP4 by reading a module associated with the read virtual server VM3 from the relation information exemplified in FIG. 11.

Next, the similarity calculation unit 202 specifies, for example, a service associated with a module standing for an application from among the modules read in the service information (step S302). For example, the similarity calculation unit 202 specifies services SV1 and SV3 by reading services associated with the read application AP4 from the service information exemplified in FIG. 13.

Next, the similarity calculation unit 202 specifies modules associated with the service specified at step S302 from among the modules in the system providing the service (step S303). The similarity calculation unit 202 specifies a service and modules required for implementing the service in the system in this processing. If there is any other modules that mediate between the service and the modules, the similarity calculation unit 202 specifies the mediating module in this processing.

While, in the above-described example, the similarity calculation unit 202 reads relation information and, then, reads service information, the similarity calculation unit 202 may not necessarily follow such a processing flow.

For example, in the relation information as exemplified in FIG. 11, the physical server PS2 is associated with the virtual server VM3, and the virtual server VM3 is associated with the application AP4. Further, the application AP4 is associated with the services SV1 and SV3. Thus, in the relation information as exemplified in FIG. 11, the physical server PS2 is associated with the services SV1 and SV3 via the virtual server VM3 and the application AP4.

For example, the similarity calculation unit 202 reads the applications AP1 and AP4 by reading modules associated with the service SV1 from the service information exemplified in FIG. 13. Next, the similarity calculation unit 202 reads the virtual server VM1 by reading a module associated with the read application AP1 from the relation information exemplified in FIG. 11.

Further, the similarity calculation unit 202 reads the virtual server VM4 by reading a module associated with the read application AP3 from the relation information exemplified in FIG. 11. Next, the similarity calculation unit 202 reads the physical server PS1 by reading a module associated with the read virtual server VM1 from the relation information exemplified in FIG. 11. Next, the similarity calculation unit 202 reads the physical server PS2 by reading a module associated with the read virtual server VM4 from the relation information exemplified in FIG. 11.

In the service information exemplified in FIG. 13, the service SV1 is associated with the application AP1. Further, in the relation information exemplified in FIG. 11, the application AP1 is associated with the virtual server VM4 and the virtual server VM4 is associated with the physical server PS2.

In such a case, the similarity calculation unit 202 specifies association between the service SV1 and the physical server PS1 and further specifies the mediating modules; the application AP1 and the virtual server VM1, in between the service SV1 and the physical server PS1. Further, in such a case, the similarity calculation unit 202 specifies association between the service SV1 and the physical server PS2 and further specifies the mediating modules; the application AP4 and the virtual server VM4, in between the service SV1 and the physical server PS1.

As described above, the similarity calculation unit 202 specifies a service and modules associated with the service (target modules, such as, the physical server PS1, the virtual server VM1, and the like) on the basis of the relation information and service information. Further, the similarity calculation unit 202 specifies a module mediating between the service and the modules.

Next, when a specific service and a specific module are associated with one another, the similarity calculation unit 202 calculates a degree of influence in accordance with the recovery rates of modules mediating between the specific service and the specific module and the like (step S304). The similarity calculation unit 202 calculates the degree of influence exerted by the specific module on the specific service, for example, by calculating the sum of the inverse numbers of the recovery rates of the modules mediating between the specific service and the specific module.

For example, when the specific module is a physical server, the similarity calculation unit 202 calculates the degree of influence that a physical server PSᵢ (i.e., the specific module) exerts on an application APₖ in accordance with Eqn. 2, where i, k are natural numbers.

Degree of influence(PSᵢ→APₖ)=1÷μ_{PSi}+1÷μ_{VMj}+1÷μ_{APk} (Eqn. 2)

(where μ_{PSi} represents a recovery rate of a physical server PSᵢ; μ_{VMj} represents a recovery rate of a virtual server VMⱼ; μ_{APk} represents a recovery rate of an application APₖ; and j represents a natural number.)

Further, when a specific module is a virtual server, the similarity calculation unit 202 calculates the degree of influence that the virtual server VMᵢ exerts on the application APₖ in accordance with Eqn. 3.

Degree of influence(VMᵢ→APₖ)=1÷μ_{VMi}+1÷μ_{APk} (Eqn. 3)

(where μ_{VMi} represents a recovery rate of the virtual server VMᵢ; and μ_{APk} represents a recovery rate of the application APₖ.)

Next, to calculate the degree of influence that a specific module exerts on a service SVₘ, the similarity calculation unit 202 calculates the sum of the degrees of influence that the specific module exerts on applications involved in the service SVₘ. For example, the similarity calculation unit 202 calculates the degree of influence that the physical server PSᵢ exerts on the service SVₘ in accordance with Eqn. 4, where m is a natural number.

Degree of influence(PSᵢ→SVₘ)=Σdegree of influence(PSᵢ→APₖ) (Eqn. 4)

(where Σ indicates the sum of the degrees of influence on APₖ involved in SVₘ)

The similarity calculation unit 202 calculates the degree of influence that the virtual server VMᵢ exerts on the service SVₘ in accordance with Eqn. 5.

Degree of influence(VMᵢ=SVₘ)=Σdegree of influence(VMᵢ→APₖ) (Eqn. 5)

(where Σ indicates the sum of the degrees of influence on APₖ involved in

SVₘ)

While the similarity calculation unit 202 calculates the degree of influence on the basis of recovery rates in the above-described example, the degree of influence may be calculated on the basis of failure rates, or the failure rates and recovery rates by performing processing that is similar to the calculation of the degree of influence on the basis of the recovery rates. For example, the similarity calculation unit 202 may calculate the degree of influence by using the inverse numbers of failure rates instead of the above-described inverse numbers of the recovery rates. Alternatively, the similarity calculation unit 202 may calculate the degree of influence by using the inverse number of a harmonic mean of recovery rates and failure rates instead of the above-described inverse numbers of the recovery rates.

The similarity calculation unit 202 may use average time interval between timings of failures of modules, average recovery time, the count of failures, the count of successful recoveries from occurring failures, or the like, instead of the inverse numbers of recovery rates. That is, the method for calculating the degree of influence by the similarity calculation unit 202 is not limited to the above-described examples.

Next, the similarity calculation unit 202 may calculate the module influence information exemplified in FIG. 5 by associating the degrees of influence calculated by performing the processing from steps S301 to S304 with one another.

The following will describe the effect of the causes ordering estimation device 201 according to the second example embodiment.

In addition to the effect of the first example embodiment, the causes ordering estimation device 201 of the second example embodiment can further easily calculate the degree of influence that a module exerts on a service based on a recovery rate and the like.

This is because of the following reasons 1 and 2. That is,

(Reason 1) the components of the causes ordering estimation device 201 according to the second example embodiment includes the components of the causes ordering estimation device 101 according to the first example embodiment; and

(Reason 2) the similarity calculation unit 202 calculates the degree of influence with a small number of calculations, such as the inverse number of a recovery rate, as described above.

The causes ordering estimation device according to the above-described example embodiments may be also used to facilitate management of modules for improving availability of services in an information system, such as a cloud data center that is managed by using a mathematical model. For example, when planning elimination of a module with a high risk of causing a failure, the administrator may select a module on the basis of the order of modules calculated by the causes ordering estimation device.

### Hardware Configuration Example

A configuration example of hardware resources that realize a causes ordering estimation device in the above-described example embodiments of the present invention using a single calculation processing apparatus (an information processing apparatus or a computer) will be described. However, the availability analysis device may be realized using physically or functionally at least two calculation processing apparatuses. Further, the availability analysis device may be realized as a dedicated apparatus.

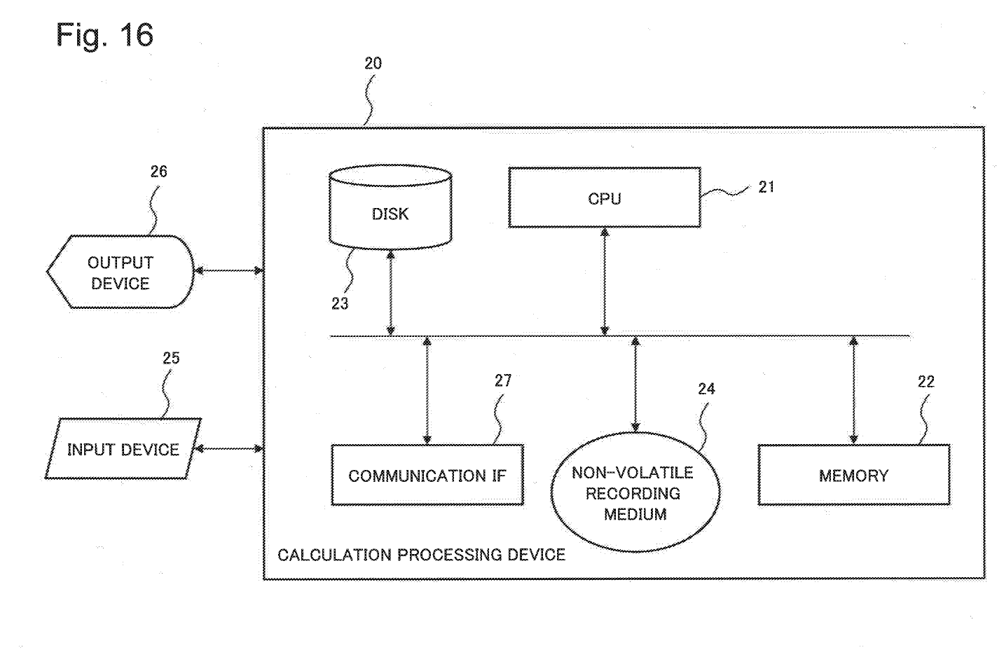

FIG. 16 is a block diagram schematically illustrating a hardware configuration of a calculation processing apparatus capable of realizing the causes ordering estimation device according to each of the first example embodiment and the second example embodiment. A calculation processing apparatus 20 includes a central processing unit (CPU) 21, a memory 22, a disc 23, a non-transitory recording medium 24, an input apparatus 25, an output apparatus 26, and a communication interface (hereinafter, expressed as a “communication I/F”) 27. The calculation processing apparatus 20 can execute transmission/reception of information to/from another calculation processing apparatus and a communication apparatus via the communication I/F 27.

The non-transitory recording medium 24 is, for example, a computer-readable Compact Disc, Digital Versatile Disc, Blu-ray Disk (registered trademark). The non-transitory recording medium 24 is, for example, Universal Serial Bus (USB) memory, or Solid State Drive. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory medium 24.

In other words, the CPU 21 copies, on the memory 22, a software program (a computer program: hereinafter, referred to simply as a “program”) stored by the disc 23 when executing the program and executes arithmetic processing. The CPU 21 reads data necessary for program execution from the memory 22. When display is needed, the CPU 21 displays an output result on the output apparatus 26. When a program is input from the outside, the CPU 21 reads the program from the input apparatus 25. The CPU 21 interprets and executes a causes ordering estimation program present on the memory 22 corresponding to a function (processing) indicated by each unit illustrated in FIG. 1, FIG. 6, FIG. 9, FIG. 11, or FIG. 17 described above or a causes ordering estimation program (FIG. 2, FIG. 3, FIG. 4, FIG. 7, FIG. 8, or FIG. 10). The CPU 21 sequentially executes the processing described in each example embodiment of the present invention.

In other words, in such a case, it is conceivable that the present invention can also be made using the causes ordering estimation program. Further, it is conceivable that the present invention can also be made using a computer-readable, non-transitory recording medium storing the causes ordering estimation program.

The present invention has been described using the above-described example embodiments as example cases. However, the present invention is not limited to the above-described example embodiments. In other words, the present invention is applicable with various aspects that can be understood by those skilled in the art without departing from the scope of the present invention.

This application is based upon and claims the benefit of priority from Japanese patent application No. 2014-114464, filed on Jun. 3, 2014, the disclosure of which is incorporated herein in its entirety.

### REFERENCE SIGNS LIST

101 Causes ordering estimation device
102 Ordering unit
501 Numerical information
201 Causes ordering estimation device
202 Similarity calculation unit
203 Ordering unit
300 Arrow
301 Arrow
302 Arrow
303 Arrow
304 Arrow
305 Arrow
20 Calculation processing device
21 CPU
22 Memory
23 Disk
24 Non-volatile recording medium
25 Input device
26 Output device
27 Communication IF

What is claimed is:

1. A causes ordering estimation device
configured to determine an order of modules in accordance with a degree of similarity between a numeric value relating to a service provided by using a system and a degree of influence representing a magnitude of influence that the module in the system exerts on the service.

2. The causes ordering estimation device according to claim 1, wherein
in determining the order, calculates a degree of similarity representing resemblance between the numeric value and the degree of influence and determines an order of the modules in accordance with the calculated degree of similarity.

3. The causes ordering estimation device according to claim 2, further comprising:
an influence calculation unit configured to specify a first module associated with the service on basis of service information that associates the service with the modules, calculate a sum of a first degree of influence representing a magnitude of influence that a second module, which is different from the first module among the modules, exerts on the first module, and set the calculated value as the degree of influence that the first module exerts on the service.

4. The causes ordering estimation device according to claim 3, wherein,
when the module in the service is an application program, the influence calculation unit calculates the first degree of influence on basis of a recovery degree representing how easily a target module in the application program can be recovered from a failure.

5. The causes ordering estimation device according to claim 4, wherein
the influence calculation unit specifies the target module by specifying a module associated with the module standing for the application program on basis of relation information in which the plurality of modules are associated with one another.

6. The causes ordering estimation device according to claim 1, wherein
the numeric value represents a period during which the service is not in operation, and
in determining the order, determines an order of the modules in terms of the period during which the service is not in operation.

7. The causes ordering estimation device according to claim 1, wherein
the numeric value represents a number of complaints relating to the service, and
in determining the order, determines an order of the modules in terms of the number of complaints.

8. The causes ordering estimation device according to claim 2, wherein
in determining the order, calculates the degree of similarity on basis of an inner product or a distance between a vector including the degrees of influence and a vector including the numeric value.

9. A causes ordering estimation method comprising:
determining an order of modules in accordance with a degree of similarity between a numeric value relating to a service provided by using a system and a degree of influence representing a magnitude of influence that the module in the system exerts on the service.

10. A non-volatile recording medium that stores a causes ordering estimation program that causes a computer to implement:
an ordering function configured to determine an order of modules in accordance with a degree of similarity between a numeric value relating to a service provided by using a system and a degree of influence representing a magnitude of influence that the module in the system exerts on the service.
